(19) United States
(12) Patent Application Publication
(10) Pub. No.: US 2011/0001598 A1
(43) Pub. Date: Jan. 6, 2011

(54) TRANSFORMER AND METHOD OF MANUFACTURING THE SAME

(75) Inventors: Soo Deok MOON, Suwon (KR); Jae Gen Eom, Hwaseong (KR); Sang Hun Joung, Suwon (KR); Yong Ju Oh, Hwaseong (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/642,011

(22) Filed: Dec. 18, 2009

(30) Foreign Application Priority Data
Jul. 3, 2009 (KR) 10-2009-0060648

(51) Int. Cl. H01F 27/36; H01F 27/30

(52) U.S. Cl. 336/198; 29/606

(57) ABSTRACT

There is provided a transformer and a method of manufacturing the same. The transformer includes a bobbin wound with coils; cores having center leg parts inserted from both ends of the bobbin and contacting each other; and a shielding member preventing an inflow of an impregnant into the center leg parts inside the bobbin during a varnish impregnation of the cores.

### CROSS-REFERENCE TO RELATED APPLICATIONS

This application claims the priority of Korean Patent Application No. 10-2009-0060648 filed on Jul. 3, 2009, in the Korean Intellectual Property Office, the disclosure of which is incorporated herein by reference.

### BACKGROUND OF THE INVENTION

1. Field of the Invention

The present invention relates to a transformer and a method of manufacturing the same, and more particularly, to a transformer and a method of manufacturing the same for preventing cracks from occurring in a center leg connection part extended from a core.

2. Description of the Related Art

A transformer is a device that varies an alternating voltage and a current value using electromagnetic induction, and it is an indispensable element of electronic devices. The transformer is manufactured by winding coils surrounding a large magnetic core. A first coil is connected to an input circuit serving to vary a voltage and a second coil is connected to an output circuit serving to use the varied voltage.

In general, a transformer includes cores whose center leg parts are in contact with each other and are combined by a bonding process using an adhesive, and a bobbin enclosing the center leg parts and wound with coils.

Since the cores composed of ferrite materials are brittle, they are susceptible to mechanical shock. Particularly, cracks may easily occur due to thermal shock caused by rapid temperature variations during repeated heating and cooling.

The adhesive bonding between the center leg parts plays an important role in preventing vibration and noise occurring when the transformer operates. However, due to a large difference in thermal expansion coefficients between the cores and the adhesive, the expansion or contraction of the adhesive is greater than that of the cores during heating or cooling. Accordingly, considerable thermal stress occurs in the cores, and thus cracks occur at the edges of the connection parts between the center leg parts and the cores.

### SUMMARY OF THE INVENTION

An aspect of the present invention provides a partially varnish impregnated transformer and a method of manufacturing the same, in which the center leg parts of cores are unbound to each other with an adhesive, and a shielding member serving to prevent a vacuum varnish impregnation shields a center leg insertion hole of a bobbin, in order to prevent the occurrence of cracks in the center leg parts of the cores.

According to an aspect of the present invention, there is provided a transformer including: a bobbin wound with coils; cores having center leg parts inserted from both ends of the bobbin and contacting each other; and a shielding member preventing an inflow of an impregnant into the center leg parts inside the bobbin during a varnish impregnation of the cores.

The center leg parts may be disposed inside a center leg insertion hole of the bobbin, and the shielding member may shield the center leg insertion hole.

The shielding member may be interposed between opposing surfaces of the bobbin and the cores.

The shielding member maybe an impregnation-protection pad preventing the inflow of the impregnant.

The shielding member may be an adhesive bonding the center leg insertion hole of the bobbin and the center leg parts.

The center leg parts may be inserted into the center leg insertion hole of the bobbin without a space, and the shielding member may be an adhesive applied to the center leg insertion hole and fixing the center leg parts.

The shielding member may be a filler filled inside a space between the center leg insertion hole of the bobbin and the center leg parts.

According to another aspect of the present invention, there is provided a method of manufacturing a transformer, the method including: inserting center leg parts of cores into both ends of a bobbin wound with coils to cause the center leg parts to contact each other and shielding a center leg insertion hole of the bobbin with a shielding member preventing an inflow of a varnish impregnant; and immersing the cores in the varnish impregnant to cause an area surrounding the center leg parts to be a non-impregnated area and an area excepting the non-impregnated area of the cores to be an impregnated area.

The shielding member maybe an impregnation-protection pad preventing the inflow of the impregnant.

The shielding member may be an adhesive bonding the center leg insertion hole of the bobbin and the center leg parts.

The center leg parts may be inserted into the center leg insertion hole of the bobbin without a space, and the shielding member may be an adhesive applied to the center leg insertion hole and fixing the center leg parts.

The shielding member may be a filler filled inside a space between the center leg insertion hole of the bobbin and the center leg parts.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a transformer according to an exemplary embodiment of the present invention;

FIG. 2 is an exploded perspective view of a transformer according to an exemplary embodiment of the present invention;

FIG. 3 is a schematic cross-sectional view illustrating an example 1 of a shielding member used in a transformer according to an exemplary embodiment of the present invention;

FIG. 4 is a schematic cross-sectional view illustrating an example 2 of a shielding member used in a transformer according to an exemplary embodiment of the present invention;

FIG. 5 is a schematic cross-sectional view illustrating an example 3 of a shielding member used in a transformer according to an exemplary embodiment of the present invention;

FIG. 6 is a schematic plan view illustrating a varnish-impregnated area and a non-impregnated area of a transformer according to an exemplary embodiment of the present invention; and

FIG. 7 is a schematic plan view illustrating directions of force applied to center leg parts when the temperature of a transformer is changed according to an exemplary embodiment of the present invention.

### DETAILED DESCRIPTION OF THE PREFERRED EMBODIMENT

Exemplary embodiments of the present invention will now be described in detail with reference to the accompanying drawings.

Also, throughout the drawings, the same reference numerals will be used to designate the same or like parts.

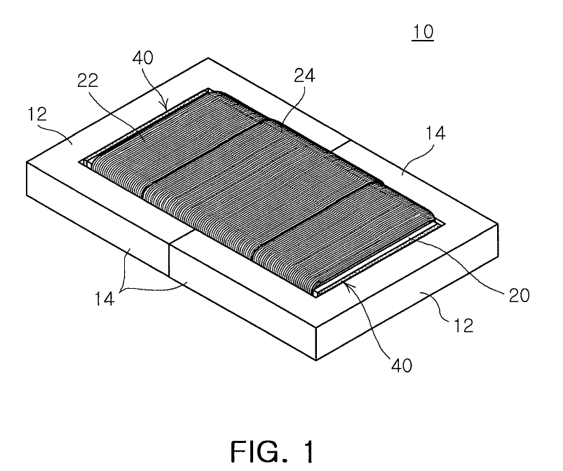

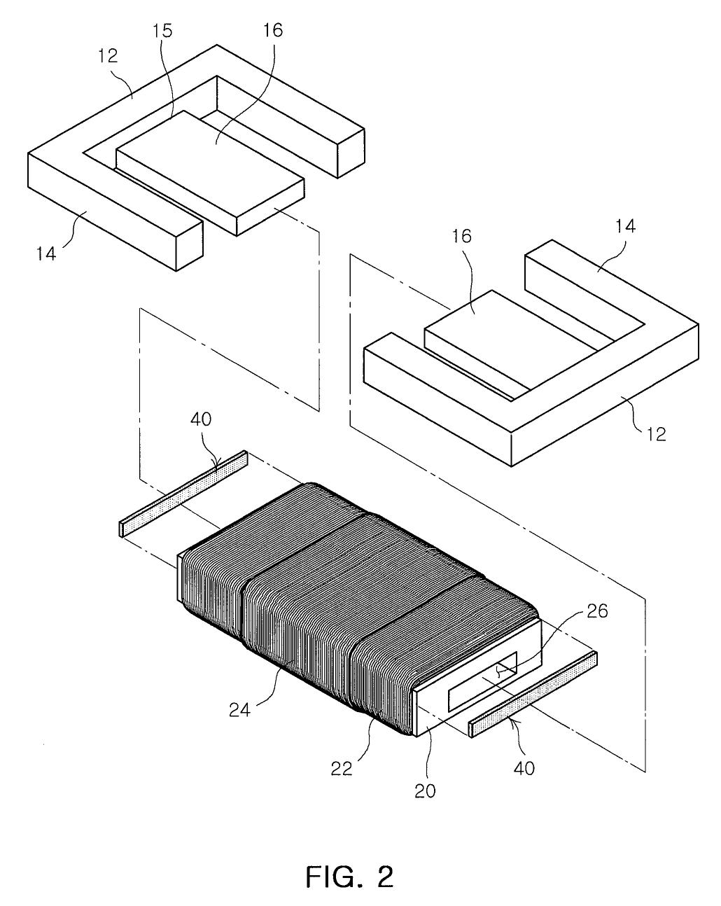

FIG. 1 is a schematic perspective view of a transformer according to an exemplary embodiment of the present invention. FIG. 2 is an exploded perspective view of a transformer according to an exemplary embodiment of the present invention.

A transformer 10 according to an exemplary embodiment of the invention includes a bobbin 20, cores 12, center leg parts 16, and a shielding member 40.

The bobbin 20 may have a rectangular cross section. Inside the bobbin 20, a center leg insertion hole 26, in which the center leg parts 14 can be inserted, maybe formed. A first coil 22 may be wound on an outer surface of the bobbin 20 and a second coil 24 may be wound on an outer surface of the first coil 22.

The cores 12 may be combined with the bobbin 20 wound with the coils 22 and 24.

The winding and arrangement of the first and second coils 22 and 24 may be variable according to the selection of a person having ordinary skill in the art.

The cores 12 are sintered bodies manufactured by a sintering process of ferrite material powder, and they have an “E” shape. That is, the cores 12 have outer leg parts 14 at the respective edges thereof, and the center leg parts 16 are formed between the outer leg parts 14.

The transformer 10 may allow the center leg parts 16 of the cores 12 to contact each other by being inserted into both ends of the center leg insertion hole 26 of the bobbin 20. At this time, the center leg parts 16 may contact each other without the use of an adhesive.

In this transformer 10, the center leg parts 16 may maintain a certain degree of plasticity within the bobbin 20, and the concept of partial impregnation may also be introduced to prevent contact between the center leg parts 16 for combining the bobbin 20 with the cores 12 and fixing the coil 22 to the bobbin 20.

When the transformer 10 is immersed in a varnish impregnant, the utilization of partial impregnation prevents the inflow of the impregnant into the center leg parts 16, thereby allowing the interior of the bobbin 20 not to be impregnated.

When the transformer 10 is immersed in the varnish impregnant, the shielding member 40 prevents the inflow of the impregnant into the center leg parts 16 inside the bobbin 20. Here, the shielding member 40 may shield the center leg insertion hole 26 and be interposed between the opposing surfaces of the bobbin 20 and the cores 12.

In this embodiment, the shielding member 40 is shown to have a rectangular shape; however, it may be formed to have a hollow interior according to how the center leg parts 16 are inserted into the center leg insertion hole 26.

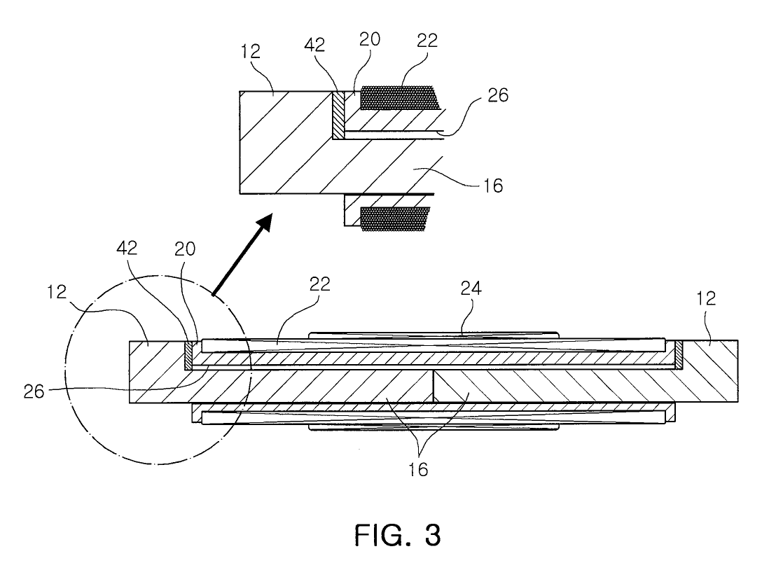

Hereinafter, examples of the shielding member allowing for the partial impregnation will be described with reference to FIGS. 3 through 5.

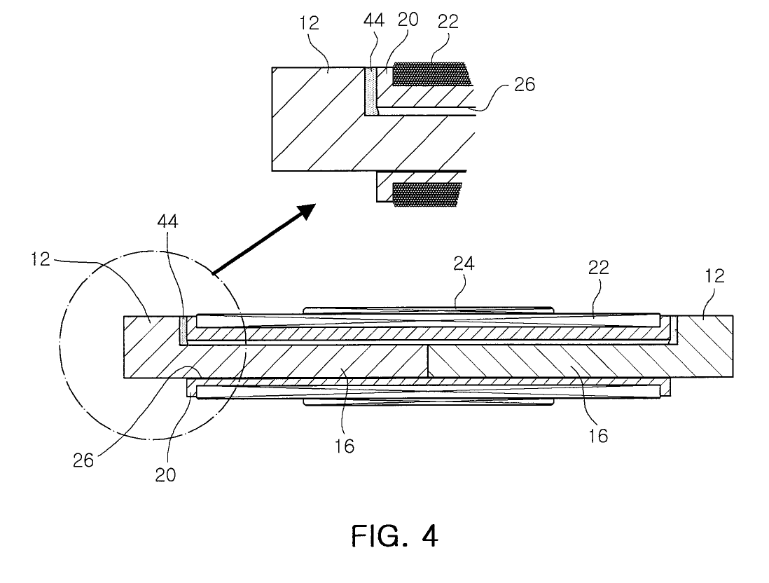

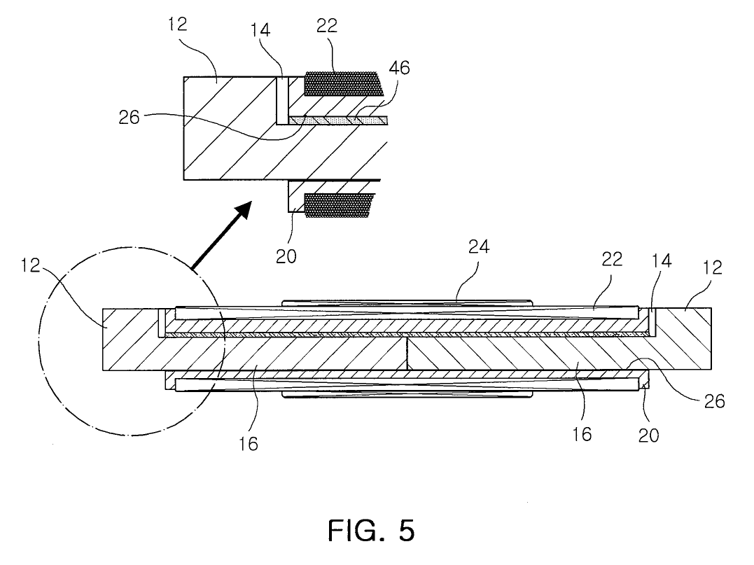

FIG. 3 is a schematic cross-sectional view illustrating an example 1 of a shielding member used in a transformer according to an exemplary embodiment of the present invention. FIG. 4 is a schematic cross-sectional view illustrating an example 2 of a shielding member used in a transformer according to an exemplary embodiment of the present invention. FIG. 5 is a schematic cross-sectional view illustrating an example 3 of a shielding member used in a transformer according to an exemplary embodiment of the present invention.

FIG. 3 shows the use of an impregnation-protection pad 42 as the shielding member. The impregnation-protection pad 42 may shield the center leg insertion hole 26 to prevent the inflow of the varnish impregnant into the bobbin 20.

FIG. 4 shows the use of an adhesive 44 as the shielding member. The adhesive 44 may be applied to an inlet surface of the center leg insertion hole 26 to fix the center leg parts 16 inserted into the center leg insertion hole 26 of the bobbin 20 without a space.

FIG. 5 shows the use of a filler 46 as the shielding member. The filler 46 may be filled inside a space between the center leg parts 16 and the bobbin 20 having the center leg parts 16 inserted therein.

A method of manufacturing the transformer 10 by the partial impregnation with the use of the shielding member 40 is described as follows.

The center leg parts 16 of the cores 12 contact each other by being inserted into both ends of the bobbin 20 wound with the coils 22 and 24, and the shielding member 40 shields the center leg insertion hole 26 of the bobbin 20 to prevent the inflow of the varnish impregnant.

The cores 12 with the shielding member 40 are immersed in the varnish impregnant to cause the area surrounding the center leg parts 16 to be a non-impregnated area and the area excepting the non-impregnated area of the cores 12 to be an impregnated area, whereby a partially-impregnated transformer is manufactured.

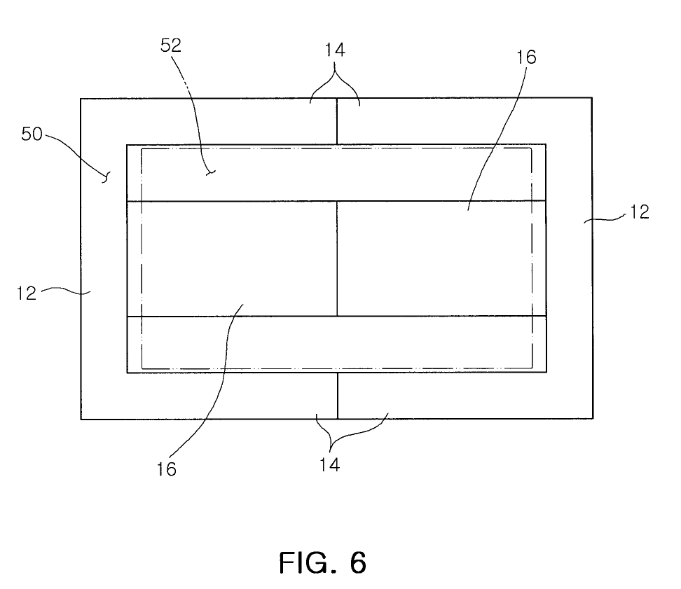

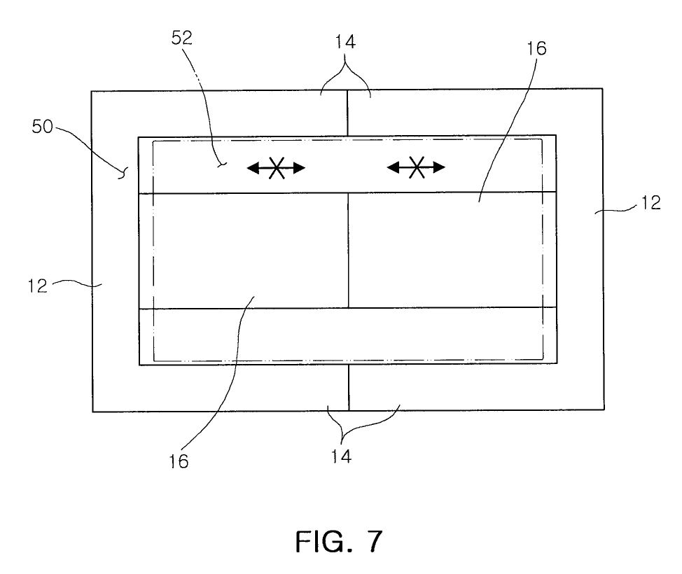

FIG. 6 is a schematic plan view illustrating a varnish-impregnated area and a non-impregnated area of a transformer according to an exemplary embodiment of the present invention. FIG. 7 is a schematic plan view illustrating directions of force applied to center leg parts when the temperature of a transformer is changed according to an exemplary embodiment of the present invention.

The partially-impregnated transformer 10 has the non-impregnated area 52 within the center leg parts 16 inside the bobbin 20 and the impregnated area 50 in the rest of the transformer 10. Here, the impregnated area 50 allows for the combination of the bobbin 20 and the cores 12 and the fixing of the coil 22 to the bobbin 20.

In FIG. 7, when rapid heating and cooling of the partially-impregnated transformer 10 is continuously repeated (defined as a thermal shock test), the action of force can be viewed.

The center leg parts 16 do not contact each other in the non-impregnated area 52, and pushing or pulling force is not exerted between the center leg parts 16, and therefore, cracks may not occur in connection parts of the cores 12 and the center leg parts 16.

The thermal shock test was conducted by comparing a fully-impregnated transformer with the partially-impregnated transformer according to the embodiment of the present invention.

Here, the conditions of the thermal shock test were controlled such that the transformer cooling and heating temperatures and times were continuously changed between 30 minutes at 85° C. and 30 minutes at −40° C. (a cycle is defined as a single cooling duration and a single heating duration evenly applied during a one hour period).

In the case of the fully-impregnated transformer, cracks occurred at the edges where the cores 12 and the center leg parts 16 are connected in a fifth cycle. On the other hand, in the case of the partially-impregnated transformer, cracks did not occur even during the hundredth cycle.

This simulation result can be evaluated as a proof of the incomparable durability of the partially-impregnated transformer over the fully-impregnated transformer.

In the transformer and the method of manufacturing the transformer according to the embodiments of the invention, since bonding between the center leg parts of the cores with the adhesive is not performed and the area surrounding the contacted center leg parts is not impregnated, the combination of forces between the center leg parts of the cores and between the cores and the bobbin may be reduced. Accordingly, even during the rapid temperature variation test of the transformer, there is no force of gravity between the center leg parts of the cores and between the cores and the bobbin, thereby considerably reducing the frequency of crack occurrence at the edges of the connection parts of the center leg parts and the cores.

Also, even though there is a temperature variation in the transformer, there is no force of gravity between the center leg parts of the cores, so vibration and noise may be reduced.

As set forth above, in the transformer and the method of manufacturing the transformer according to exemplary embodiments of the invention, the center leg parts of the cores are unbound to each other with the adhesive and the area surrounding the contacted center leg parts is not impregnated, thereby reducing the combination of forces between the center leg parts of the cores and between the cores and the bobbin. Accordingly, even during the rapid temperature variation test of the transformer, the force of gravity may not be exerted between the center leg parts of the cores and between the cores and the bobbin, whereby the frequency of crack occurrence at the edges of the connection parts of the center leg parts and the cores may be considerably reduced.

Also, although the transformer is subject to temperature variations, the force of gravity may not be exerted between the center leg parts of the cores, so vibration and noise may be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A transformer comprising:
a bobbin wound with coils;
cores having center leg parts inserted from both ends of the bobbin and contacting each other; and
a shielding member preventing an inflow of an impregnant into the center leg parts inside the bobbin during a varnish impregnation of the cores.

2. The transformer of claim 1, wherein the center leg parts are disposed inside a center leg insertion hole of the bobbin,
the shielding member shields the center leg insertion hole.

3. The transformer of claim 1, wherein the shielding member is interposed between opposing surfaces of the bobbin and the cores.

4. The transformer of claim 1, wherein the shielding member is an impregnation-protection pad preventing the inflow of the impregnant.

5. The transformer of claim 1, wherein the shielding member is an adhesive bonding the center leg insertion hole of the bobbin and the center leg parts.

6. The transformer of claim 1, wherein the center leg parts are inserted into the center leg insertion hole of the bobbin without a space,
the shielding member is an adhesive applied to the center leg insertion hole and fixing the center leg parts.

7. The transformer of claim 1, wherein the shielding member is a filler filled inside a space between the center leg insertion hole of the bobbin and the center leg parts.

8. A method of manufacturing a transformer, the method comprising:
inserting center leg parts of cores into both ends of a bobbin wound with coils to cause the center leg parts to contact each other and shielding a center leg insertion hole of the bobbin with a shielding member preventing an inflow of a varnish impregnant; and
immersing the cores in the varnish impregnant to cause an area surrounding the center leg parts to be a non-impregnated area and an area excepting the non-impregnated area of the cores to be an impregnated area.

9. The method of claim 8, wherein the shielding member is an impregnation-protection pad preventing the inflow of the impregnant.

10. The method of claim 8, wherein the shielding member is an adhesive bonding the center leg insertion hole of the bobbin and the center leg parts.

11. The method of claim 8, wherein the center leg parts are inserted into the center leg insertion hole of the bobbin without a space,
the shielding member is an adhesive applied to the center leg insertion hole and fixing the center leg parts.

12. The method of claim 8, wherein the shielding member is a filler filled inside a space between the center leg insertion hole of the bobbin and the center leg parts.
